(19) United States
(12) Patent Application Publication
(10) Pub. No.: US 2014/0277993 A1
(43) Pub. Date: Sep. 18, 2014

(54) Motor Vehicle Lift Control System

(71) Applicants: Donald William HOOKWAY, Flanders, NJ (US); William C. HOOKWAY, III, Sparta, NJ (US)

(72) Inventors: Donald William HOOKWAY, Flanders, NJ (US); William C. HOOKWAY, III, Sparta, NJ (US)

(21) Appl. No.: 14/218,676

(22) Filed: Mar. 18, 2014

Related U.S. Application Data
(60) Provisional application No. 61/802,859, filed on Mar. 18, 2013.

(51) Int. Cl. B60R 21/0132

(52) U.S. Cl. CPC B60R 21/0132
USPC 701/101

(57) ABSTRACT

An automatic motor vehicle lift control system responds to a motor vehicle wheelie event when a motor vehicle front lifts off from an operating surface. It functions to reduce power output from an engine of a vehicle in wheelie to prevent an accident. This automatic motor vehicle lift control system includes a number of functional components including sensor, central processing unit (cpu), control actuator and user interface. The sensor may be mounted on an external location of a vehicle. It functions to gather information of a physical state of a motor vehicle and then send it to the cpu for processing. The cpu receives input from the sensor and the user interface, as well as conduct processing and determination. The control actuator received order from the cpu and then act on the vehicle to avoid a wheelie accident.

The current application claims a priority to the U.S. Provisional Patent Application Ser. No. 61/802,859, filed on Mar. 18, 2013.

### FIELD OF THE INVENTION

The present invention relates generally to motorized vehicles. More specifically it is a motorized vehicle lift control system which helps to prevent flipping over during driving.

### BACKGROUND OF THE INVENTION

Throughout history, humankind has always sought a method of faster travel. The advent of motorized vehicles has allowed people to travel over great distances in a quite short period of time. Motorized ships, cars, and planes, were all developed to allow for much faster transport of both trade goods and people. Although motorized vehicles were developed originally to serve as transportation from one location to another, they were designed to do so at an increased speed when compared with other methods. This fact has since spawned a subgroup of motorized vehicles which are not built primarily for efficient and quick transportation, but instead to simply go as fast as possible.

The high performance vehicles have been designed, tested, and redesigned in an attempt to obtain an ever increasing amount of speed out of the vehicles. This can be seen in the history of motorized vehicles and covers many different types of motorized vehicles such as cars, motorcycles, and motorboats. The use of high performance vehicles in events specifically designed around the speed of those vehicles is often called racing. Racing involves the participation of at least one driver who pilots a motorized vehicle as fast as possible within a predefined area often called a race track.

Whenever a high performance vehicle is piloted at high speeds, there are significant risks to the pilot of that vehicle, particularly under certain conditions. One such condition that can put the vehicle pilot in significant danger is known as a wheelie. A wheelie occurs when the front of the vehicle lifts off the ground as a result of the excessive amounts of torque on the rear axle of the motor vehicle.

Wheelies most commonly occur in drag races in which the pilot of the vehicle attempts to cover a certain straight line distance as fast as possible. Since the motor vehicle starts the drag race from a standstill, the conditions are ripe for the occurrence of a wheelie as huge amounts of torque are delivered to the rear axle of the motor vehicle in an attempt to accelerate as fast as possible. Though impressive and exciting to behold, wheelies can be dangerous to the pilot of the motor vehicle for several reasons. Firstly, the pilot is largely unable to steer the vehicle when the front wheel or wheels are off the ground. This can make it very easy to lose control of the motor vehicle and careen off the race track at a high speed. Secondly, the pilot can sometimes apply such an excessive amount of torque that the vehicle continues to spin backwards eventually either flipping over entirely or damaging the rear of the vehicle. The chance of flipping the motor vehicle entirely is much higher in motorcycles due to their relatively light weight and compact construction when compared to cars.

In order to help reduce the dangers of wheelies, many high performance vehicles that are prone to experiencing wheelies are equipped with certain safety devices which allow the pilot to cut power to the engine, downshift, deactivate fuel flow, or otherwise reduce the power output of the engine such that the wheelie is no longer sustained. Unfortunately, these safety devices are manually triggered, relying on the pilot of the vehicle to trigger the safety device if it becomes necessary. In some cases, the pilot may not be able to react fast enough, or they may make a poor judgment call and fail to activate the safety device soon enough to prevent a disaster. It is clear that there is a need for an automated safety device which automatically activates when certain thresholds are reached or exceeded. Therefore, it is an objective of the present invention to create a system which accomplishes this, deactivating or otherwise reducing the power output of a motor vehicles engine when certain metrics have been met or surpassed.

### BRIEF DESCRIPTION OF THE DRAWINGS

FIG. 1 is a perspective view of the physical components of the present invention.

FIG. 2 is another perspective view thereof displaying a computer interface cable extended from the apparatus.

FIG. 3 is a perspective detail view of the sensor installed on a car.

FIG. 4 is a right side view of the car with the sensor installed on the front.

FIG. 5 is a perspective detail view of the sensor installed onto the front of a motorcycle.

FIG. 6 is a right side view of the motorcycle with the sensor installed on the front.

FIG. 7 is a flow chart depicting how the system interacts with external inputs.

FIG. 8 is a block diagram depicting the basic layout of the system.

### DETAIL DESCRIPTIONS OF THE INVENTION

All illustrations of the drawings are for the purpose of describing selected versions of the present invention and are not intended to limit the scope of the present invention.

The present invention is an automatic motor vehicle lift control system. It comprises a few functional components which interact with one another in specific ways, thus forming the system of the present invention.

This automatic motor vehicle lift control system includes a sensor 101, which provide sensor inputs, a cpu (central processing unit) 102, a control actuator 103, which provides control outputs to the vehicle, and a user interface 104. It operates upon certain parameters which are entered into the system via the user interface. The parameters define physical values which represent the operational characteristics of the system, the distance of the front of the motor vehicle from the operating surface, or the angle of the vehicle relative to downward gravitational forces. The sensor(s) allows the present invention to gather information which reflects the current physical state of the motor vehicle. The sensor is interconnected with the cpu, and changes in the physical state of the vehicle cause changes in the electrical signal received by the cpu from the sensor. The variations are interpreted by the cpu such that the metrics regarding the physical state of the motor vehicle are determined. Those metrics are then compared to the parameters entered into the system by the user. As observed in FIG. 10, it is possible that there be some signal conditioning performed between the sensor and the cpu.

In regard to the sensor, based on its particular function, the sensor 101 may be attached to the motor vehicle either externally or internally. FIG. 5 through FIG. 8 display the sensor attached to the front of a car or to the front of a motorcycle. The exact position of the sensor is subject to change and may vary depending upon the type of sensor used in the system. It is obvious that there are many different kinds of sensor which may be utilized by the system in order to determine the physical state of the vehicle. Mounting a range finding sensor on the front of the vehicle may be effective as the purpose of the present invention is to determine when the front of the vehicle raises off the ground by a certain amount as defined by the parameters entered by the user.

Alternatively, a microelectromechanical system (MEMS) inclinometer may be utilized to allow the system to determine when the car has rotated a certain angle relative to horizontal. MEMS inclinometers operated based upon acceleration vectors, particularly gravity which represents the zero mark in most inclinometers. As a result of this, the position of the sensor somewhere on the motor vehicle is not particularly important and may vary depending upon the preferences of the user. Since MEMS inclinometers operated based upon acceleration vectors, it is possible that the system may register some anomalous values when the motor vehicle is first accelerating. It may be necessary for the cpu to account for these anomalous readings. The present invention is not limited to only what is described above, and any other type of electronic sensor which could be implemented to determine the physical condition of the motor vehicle may also be used in the system.

In addition, concerning the sensor, it may also be accelerometer, gyroscope, sonic range finder, resistive sensor, limit switch, strain gauge and etc. However, the sensor of the present invention can be any device suitable for the aforementioned function of the sensor in the present invention.

In the present invention, the cpu 102 is responsible for receiving input from both the sensor and from the user interface of the present invention as well as comparing the inputs to one another. Comparison between the inputs from the sensor and the inputs from the user interface allow the system of the present invention to react accordingly. The inputs from the user interface are the parameters which define thresholds which the user does not want their motor vehicle to cross over. The parameters may be entered in angle or in distance depending upon the type of sensor used and or the inherent programming of the cpu. The signal received by the cpu from the sensor is processed such that it may be compared to the parameters as input by the user. If the signal received by the cpu from the sensor is representative of metrics that exceed the parameters, then the cpu triggers an signal to the control actuator.

The control actuator 103 serves as the output interface of the present invention to the motor vehicle to which the present invention is mounted. FIG. 2 displays a very basic illustration of the present invention which shows the cpu and the control actuator connected to one another via a communications cable 106. The cpu may be located in a VLS (vehicle lift control system). Alternatively, it is possible that the cpu may be housed alone and removable from the system. This would allow the present invention to be more modular, perhaps allowing for easy replacement of the sensor, control actuator, or cpu. Additionally, multiple sensors and multiple control actuators may even be attached to the cpu, allowing for a wider range of applications of the present invention such as advanced performance monitoring and real time performance modification which is controlled by the cpu. In the most basic embodiment of the present invention, the control actuator simply acts to reduce the power output of the engine of the motor vehicle. The output signal either activates, deactivates or modulates the control actuator depending on the specific design of the system and the exact action performed by the control actuator to reduce the power output of the engine.

The control actuator could function to control the vehicle lifting via controlling various vehicle parts, such as air shifter, the ignition system or the fuel injection system. As for the ignition system, it may be either a rev limiter, which restricts engine's maximum rotational speed, or functions as a total ignition kill. As for the fuel injection system, it may be the auto throttle, the fuel injector, the nitrous oxide engine or the turbocharger.

Furthermore, it is important to note that the connection between the cpu and the control actuator does not necessarily need to be by physical cable 106 as displayed in FIG. 1. Alternatively, some other form of information transmission such as wireless radio may be used to activate, deactivate or modulate the control actuator as dictated by the cpu.

The automatic motor vehicle lift control system of the present invention also includes the user interface 104 which allows the user to perform several functions. The user interfaces may be switches, pots, led touch panels, lcd touch panels, or some kind of computing device such as a laptop computer or a tablet computer. The computing device is then connected to the cpu via some standard communication method including but not limited to universal serial bus (USB), Wi-Fi, RS-232, and IrDA. FIG. 3 displays an example of how the communication method may physically appear on the present invention. The method of communication between the cpu and the user interface may be any of the standard methods as discussed above, be it a wired or a wireless connection. The primary purpose of the user interface is to allow the user to set the parameters which define the thresholds used by the present invention during operation. As previously discussed, the threshold values are used by the cpu to make comparison to the values discerned by the sensor. Additionally, the user interface may allow the present invention to output values gathered by the sensor versus time. In the case that multiple sensors are used in the present invention, it is possible that some very useful performance information about the motorized vehicle may be discovered. Furthermore, it is possible for the user to set whether they want the present invention to enforce a reduction in the height or angle of the front of the based on threshold values, or if the user wants the present invention to use feedback logic to maintain the threshold value. This function is similar in concept to cruise control which is commonly found in cars, and maintains the speed of the car at a user defined value.

It is also important to note that the optional communications between the cpu, laptop or tablet allow the present invention to receive firmware and software updates. These updates could work to improve the accuracy of the present invention, or to reconfigure the system to allow for different applications of the present invention. For example, the present invention could be updated from using only an inclinometer, to using both an inclinometer and a tachometer and integrating those values verses one another, or versus time, thereby yielding some interesting performance related values. The possibilities for application of the present invention are numerous, and allowing for the updating of the firmware and software of the present invention ensures that the various applications can be easily implemented by a skilled user.

The present invention is designed to be applied to a sensor and a control device which are then installed onto a motorized vehicle. Pre programmed thresholds cause the motor vehicle to experience a power reduction if the sensor detects that the front of the vehicle has raised some distance off the ground or the angle of the vehicle has reached some level. This prevents the vehicle from flipping over during high performance activities such as drag racing. It is noted that the device described here is not limited to be used in a vehicle. In addition, it may be used in boats or motorcycles for a similar purpose, including high performance boats with multiple engines and factory motorcycles that are now produced with high horsepower.

Although the present invention has been explained in relation to its preferred embodiment, it is to be understood that many other possible modifications and variations can be made without departing from the spirit and scope of the invention as herein described.

What is claimed is:

1. An automatic motor vehicle lift control system, comprising
a sensor;
a central processing unit (cpu);
a control actuator;
a user interface;
said automatic motor vehicle lift control system responding to a motor vehicle wheelie event when a motor vehicle front lifts off from an operating surface; and
said automatic motor vehicle lift control system reducing power output from an engine of a vehicle in wheelie to prevent an accident.

2. The automatic motor vehicle lift control system as set forth in claim 1, comprising
said sensor gathering information of a physical state of a motor vehicle;
said information comprising a distance of said motor vehicle front from the ground, and an angle of said motor vehicle relative to a gravity; and
said information being transferred from said sensor to said central processing unit (cpu).

3. The automatic motor vehicle lift control system as set forth in claim 1, comprising
said sensor being attached externally to a motor vehicle, or said sensor being attached internally to a motor vehicle; and
when said sensor being attached externally to said motor vehicle, said sensor being at a location, and said location comprising said motor vehicle front.

4. The automatic motor vehicle lift control system as set forth in claim 1, comprising
said sensor being a range finding sensor;
said range finding sensor being located at said motor vehicle front; and
said range finding sensor measuring a distance from said motor vehicle front to the ground.

5. The automatic motor vehicle lift control system as set forth in claim 1, comprising
said sensor being a microelectromechanical system (MEMS) inclinometer;
said MEMS inclinometer being based upon acceleration vectors; and
said MEMS inclinometer measuring a rotation angle of a motor vehicle relative to horizontal.

6. The automatic motor vehicle lift control system as set forth in claim 1, comprising
said sensor being selected from the group consisting of accelerometer, gyroscope, sonic range finder, resistive sensor, limit switch and strain gauge.

7. The automatic motor vehicle lift control system as set forth in claim 1, comprising
said central processing unit (cpu) receiving a first input from said user interface;
said cpu receiving a second input from said sensor;
said second input being processed by said cpu; and
said cpu comparing said first input with the processed second input.

8. The automatic motor vehicle lift control system as set forth in claim 7, comprising
said first input comprising parameters defining thresholds that a motor vehicle should not cross over; and
said parameters comprising a value of angle and a value of distance.

9. The automatic motor vehicle lift control system as set forth in claim 1, comprising
said control actuator being coupled to said central processing unit (cpu) via a connection;
said control actuator receiving a signal from said cpu; and
said control actuator making a response to said signal.

10. The automatic motor vehicle lift control system as set forth in claim 9, comprising
said connection being a communication cable, or
said connection being a wireless connection.

11. The automatic motor vehicle lift control system as set forth in claim 9, comprising
said control actuator making said response via controlling a motor vehicle element selected from the group consisting of air shifter, ignition system, fuel injection system and a combination thereof;
controlling said ignition system comprising restricting engine's maximum rotational speed via a rev limiter, and a total ignition kill; and
controlling said fuel injection system comprising controlling auto throttle, controlling fuel injector, controlling nitrous oxide engine, controlling turbocharger and a combination of the foregoing.

12. The automatic motor vehicle lift control system as set forth in claim 1, comprising
said user interface being selected from the group consisting of switch, pot, LED touch panel, LCD touch panel and computing device;
said computing device comprising laptop computer and tablet computer;
said user interface being coupled to said cpu via a communication mean; and
said communication mean comprising universal serial bus (USB), Wi-Fi, RS-232 and IrDA.

13. An automatic motor vehicle lift control system, comprising
a sensor;
a central processing unit (cpu);
a control actuator;
a user interface;
said automatic motor vehicle lift control system responding to a motor vehicle wheelie event when a motor vehicle front lifts off from an operating surface;
said automatic motor vehicle lift control system reducing power output from an engine of a vehicle in wheelie to prevent an accident;
said sensor gathering information of a physical state of a motor vehicle;
said information comprising a distance of said motor vehicle front from the ground, and an angle of said motor vehicle relative to a gravity;
said information being transferred from said sensor to said cpu;
said sensor being attached externally to a motor vehicle, or said sensor being attached internally to a motor vehicle;
when said sensor being attached externally to said motor vehicle, said sensor being at a location, and said location comprising said motor vehicle front;
said user interface being selected from the group consisting of switch, pot, LED touch panel, LCD touch panel and computing device;
said computing device comprising laptop computer and tablet computer;
said user interface being coupled to said cpu via a communication mean; and
said communication mean comprising universal serial bus (USB), Wi-Fi, RS-232 and IrDA.

14. The automatic motor vehicle lift control system as set forth in claim 13, comprising
said sensor being a range finding sensor;
said range finding sensor being located at said motor vehicle front; and
said range finding sensor measuring a distance from said motor vehicle front to the ground.

15. The automatic motor vehicle lift control system as set forth in claim 13, comprising
said sensor being a microelectromechanical system (MEMS) inclinometer;
said MEMS inclinometer being based upon acceleration vectors; and
said MEMS inclinometer measuring a rotation angle of a motor vehicle relative to horizontal.

16. The automatic motor vehicle lift control system as set forth in claim 13, comprising
said sensor being selected from the group consisting of accelerometer, gyroscope, sonic range finder, resistive sensor, limit switch and strain gauge.

17. The automatic motor vehicle lift control system as set forth in claim 13, comprising
said central processing unit (cpu) receiving a first input from said user interface;
said cpu receiving a second input from said sensor;
said second input being processed by said cpu;
said cpu comparing said first input with the processed second input;
said first input comprising parameters defining thresholds that a motor vehicle should not cross over; and
said parameters comprising a value of angle and a value of distance.

18. The automatic motor vehicle lift control system as set forth in claim 13, comprising
said control actuator being coupled to said central processing unit (cpu) via a connection;
said control actuator receiving a signal from said cpu;
said control actuator making a response to said signal;
said connection being a communication cable, or said connection being a wireless connection;
said control actuator making said response via controlling a motor vehicle element selected from the group consisting of air shifter, ignition system, fuel injection system and a combination thereof;
controlling said ignition system comprising restricting engine's maximum rotational speed via a rev limiter, and a total ignition kill; and
controlling said fuel injection system comprising controlling auto throttle, controlling fuel injector, controlling nitrous oxide engine, controlling turbocharger and a combination of the foregoing.

19. An automatic motor vehicle lift control system, comprising
a sensor;
a central processing unit (cpu);
a control actuator;
a user interface;
said automatic motor vehicle lift control system responding to a motor vehicle wheelie event when a motor vehicle front lifts off from an operating surface;
said automatic motor vehicle lift control system reducing power output from an engine of a vehicle in wheelie to prevent an accident;
said sensor gathering information of a physical state of a motor vehicle;
said information comprising a distance of said motor vehicle front from the ground, and an angle of said motor vehicle relative to a gravity;
said information being transferred from said sensor to said cpu;
said sensor being attached externally to a motor vehicle, or said sensor being attached internally to a motor vehicle;
when said sensor being attached externally to said motor vehicle, said sensor being at a location, and said location comprising said motor vehicle front;
said user interface being selected from the group consisting of switch, pot, LED touch panel, LCD touch panel and computing device;
said computing device comprising laptop computer and tablet computer;
said user interface being coupled to said cpu via a communication mean;
said communication mean comprising universal serial bus (USB), Wi-Fi, RS-232 and IrDA;
said sensor being selected from the group consisting of accelerometer, gyroscope, sonic range finder, resistive sensor, limit switch, strain gauge, range finding sensor and microelectromechanical system (MEMS) inclinometer;
said range finding sensor being located at said motor vehicle front;
said range finding sensor measuring a distance from said motor vehicle front to the ground;
said MEMS inclinometer being based upon acceleration vectors; and
said MEMS inclinometer measuring a rotation angle of a motor vehicle in relative to horizontal.

20. The automatic motor vehicle lift control system as set forth in claim 19, comprising
said central processing unit (cpu) receiving a first input from said user interface;
said cpu receiving a second input from said sensor;
said second input being processed by said cpu;
said cpu comparing said first input with the processed second input;
said first input comprising parameters defining thresholds that a motor vehicle should not cross over;
said parameters comprising a value of angle and a value of distance;
said control actuator being coupled to said cpu via a connection;
said control actuator receiving a signal from said cpu;
said control actuator making a response to said signal;
said connection being a communication cable, or said connection being a wireless connection;
said control actuator making said response via controlling a motor vehicle element selected from the group consisting of air shifter, ignition system, fuel injection system and a combination thereof;
controlling said ignition system comprising restricting engine's maximum rotational speed via a rev limiter, and a total ignition kill; and
controlling said fuel injection system comprising controlling auto throttle, controlling fuel injector, controlling nitrous oxide engine, controlling turbocharger and a combination of the foregoing.
